(19) United States
(12) Patent Application Publication
(10) Pub. No.: US 2016/0076888 A1
(43) Pub. Date: Mar. 17, 2016

(54) ELECTRONIC APPARATUS

(71) Applicant: CANON KABUSHIKI KAISHA, Tokyo (JP)

(72) Inventor: Yusuke Shirakawa, Kawasaki-shi (JP)

(21) Appl. No.: 14/849,079

(22) Filed: Sep. 9, 2015

(30) Foreign Application Priority Data
Sep. 12, 2014 (JP) 2014-187053

(51) Int. Cl. G01C 17/38

(52) U.S. Cl. CPC G01C 17/38

(57) ABSTRACT

An electronic apparatus includes a detecting unit that detects a magnetic field and outputs a detection value corresponding to the detected magnetic field, a correcting unit that corrects the detection value according to a type of a power source connected to the electronic apparatus, and a determining unit that determines, using the corrected detection value, an azimuth in which a predetermined surface of the electronic apparatus is directed.

### BACKGROUND

1. Field of the Disclosure

The present invention relates to an electronic apparatus, a control method for the electronic apparatus, and the like.

2. Description of the Related Art

In recent years, in various electronic apparatuses, there is an increasing need for knowing an azimuth in which a predetermined surface of an electronic apparatus is directed. To meet such a need, an apparatus capable of detecting the azimuth in which the predetermined surface of the electronic apparatus is directed (an azimuth detecting apparatus such as an electronic compass) is put to practical use. For example, the electronic compass can determine the azimuth in which the predetermined surface is directed, on the basis of a detection value of a magnetic sensor, which detects a magnetic field (terrestrial magnetism), and a detection value of an acceleration sensor, which detects acceleration.

Japanese Patent Application Laid-Open No. 2000-32379 (reference 1) describes an electronic camera including an azimuth sensor. The electronic camera described in the reference 1 can associate imaging azimuth information and imaging angle information with a captured image. Japanese Patent Application Laid-Open No. 2012-90124 (reference 2) describes a method of determining an azimuth on the basis of a detection value of a terrestrial magnetism sensor in a period in which a state of an electric drive unit is a non-driven state. However, in the method described in the reference 2, timing for determining an azimuth is limited. Japanese Patent Application Laid-Open No. 2013-57601 (reference 3) describes a method of calculating an azimuth using an integration value of angular velocity. However, in the method described in the reference 3, since the integration value of angular velocity is used, detection accuracy of an azimuth is sometimes decreased.

### SUMMARY

It is assumed that an azimuth detecting apparatus such as an electronic compass is disposed in an electronic apparatus operating as an imaging apparatus (e.g., a digital single-lens reflex camera). Depending on the configuration of the electronic apparatus, for example, it is likely that a magnetic field adversely affecting the azimuth detecting apparatus less easily occurs in the vicinity of a battery chamber. So, it is assumed that the azimuth detecting apparatus is set in the vicinity of the battery chamber. None of the references 1 to 3 describes the setting of the azimuth detecting apparatus in the vicinity of the battery chamber.

In a case where the azimuth detecting apparatus is set in the vicinity of the battery chamber, it is considered that the magnitude of a magnetic field generated in the battery chamber depends on a type of a power source connected to the battery chamber. For example, even if the azimuth detecting apparatus is appropriately adjusted assuming that a power source that should be connected to the battery chamber is a power source A, in a case where a power source actually connected to the battery chamber is a power source B different from the power source A, it is likely that detection accuracy of an azimuth detected by the azimuth detecting apparatus is decreased.

In a case where the electronic apparatus has operation modes in which operating currents are different, even if a power source connected to the battery chamber is the power source A, by changing from a certain operation mode to another operation mode, it is also likely that detection accuracy of an azimuth detected by the azimuth detecting apparatus is decreased.

Therefore, even when the azimuth detecting apparatus is set in the vicinity of the battery chamber, in order to make it possible to highly accurately detect an azimuth in which a predetermined surface (e.g., an imaging surface) of the electronic apparatus is directed, a new adjusting method is necessary as an adjusting method for the azimuth detecting apparatus.

According to an aspect of the present invention, an azimuth in which a predetermined surface (e.g., an imaging surface) of an electronic apparatus is directed can be highly accurately detected.

According to an aspect of the present invention, there is provided an electronic apparatus comprising: a detecting unit that detects a magnetic field and outputs a detection value corresponding to the detected magnetic field; a correcting unit that corrects the detection value according to a type of a power source connected to the electronic apparatus; and a determining unit that determines, using the corrected detection value, an azimuth in which a predetermined surface of the electronic apparatus is directed.

According to an aspect of the present invention, there is provided a method comprising: causing a detecting unit to detect a magnetic field and output a detection value corresponding to the detected magnetic field; correcting the detection value according to a type of a power source connected to an electronic apparatus; and determining, using the corrected detection value, an azimuth in which a predetermined surface of the electronic apparatus is directed.

According to an aspect of the present invention, there is provided an electronic apparatus comprising: a detecting unit that detects a magnetic field and outputs a detection value corresponding to the detected magnetic field; a correcting unit that corrects the detection value according to an operation mode of the electronic apparatus in a case where a predetermined power source is connected to the electronic apparatus; and a determining unit that determines, using the corrected detection value, an azimuth in which a predetermined surface of the electronic apparatus is directed.

According to an aspect of the present invention, there is provided a method comprising: causing a detecting unit to detect a magnetic field and output a detection value corresponding to the detected magnetic field; correcting the detection value according to an operation mode of an electronic apparatus in a case where a predetermined power source is connected to the electronic apparatus; and determining, using the corrected detection value, an azimuth in which a predetermined surface of the electronic apparatus is directed.

Further features and aspects of the present invention will become apparent from the following description of exemplary embodiments.

### BRIEF DESCRIPTION OF THE DRAWINGS

The drawings, which are incorporated in and constitute a part of the specification, illustrate exemplary embodiments, features, and aspects of the pre sent invention.

FIG. 1 is a block diagram for illustrating an example of the configuration of an electronic apparatus 100 according to first to third embodiments;

FIG. 2 is a diagram for illustrating an example of a determining method for an imaging azimuth;

FIG. 3A is a diagram for illustrating an example of the exterior of the electronic apparatus 100 according to the first to third embodiments;

FIG. 3B is a diagram for illustrating an example of the internal structure of the electronic apparatus 100 according to the first to third embodiments;

FIG. 4 is a diagram for illustrating an example of a correction formula according to the first to third embodiments;

FIG. 5 is a flowchart for illustrating an example of a generation method for correction values according to the first to third embodiments;

FIG. 6 is a diagram for illustrating an example of power source information according to the first to third embodiments;

FIG. 7 is a flowchart for illustrating an example of a flow of the operation of the electronic apparatus 100 according to the first embodiment;

FIG. 8 is a flowchart for illustrating an example of a flow of the operation of the electronic apparatus 100 according to a second embodiment;

FIG. 9A is a diagram for illustrating an example of a first correspondence relation according to the second embodiment;

FIG. 9B is a diagram for illustrating an example of a second correspondence relation according to the second embodiment;

FIG. 10 is a flowchart for illustrating an example of a flow of the operation of the electronic apparatus 100 according to a third embodiment;

FIGS. 11A and 11B are diagrams for illustrating an example of a notification image according to the third embodiment; and

FIG. 12 is a block diagram for illustrating another configuration of the electronic apparatus 100 according to the first to third embodiments.

### DESCRIPTION OF THE EMBODIMENTS

Exemplary embodiments, features, and aspects of the present invention will be described below with reference to the drawings.

### First Embodiment

An electronic apparatus 100 and a control method for the electronic apparatus 100 according to a first embodiment are explained below.

The electronic apparatus 100 is an electronic apparatus operating as an azimuth detecting apparatus (an electronic compass, etc.) capable of detecting an azimuth in which a predetermined surface (e.g., an imaging surface) of the electronic apparatus 100 is directed. Note that, in the first to third embodiments, an example is explained in which the electronic apparatus 100 is an electronic apparatus operating as an imaging apparatus. However, the electronic apparatus 100 is not limited to the electronic apparatus operating as the imaging apparatus. For example, the electronic apparatus 100 may be an electronic apparatus operating as a digital camera such as a digital single-lens reflex camera. For example, the electronic apparatus 100 may be an electronic apparatus operating as a digital video camera. For example, the electronic apparatus 100 may be an electronic apparatus operating as a cellular phone or a portable apparatus. For example, the electronic apparatus 100 may be an electronic apparatus operating as a navigation apparatus that guides a user to a destination.

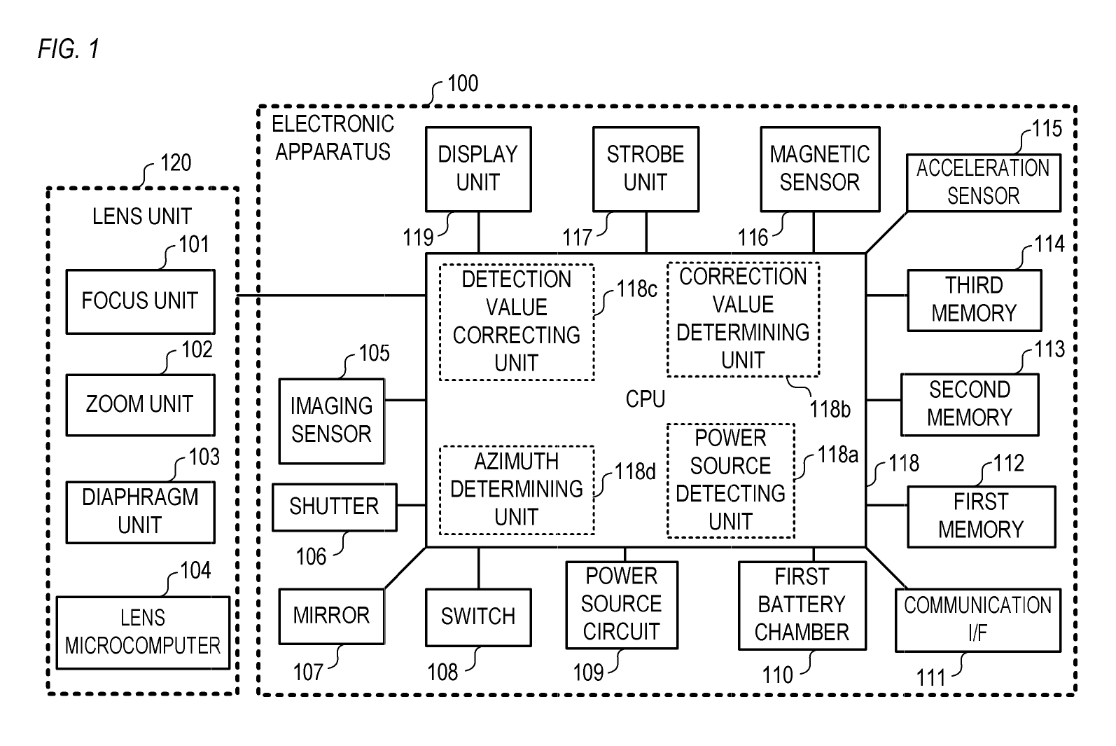

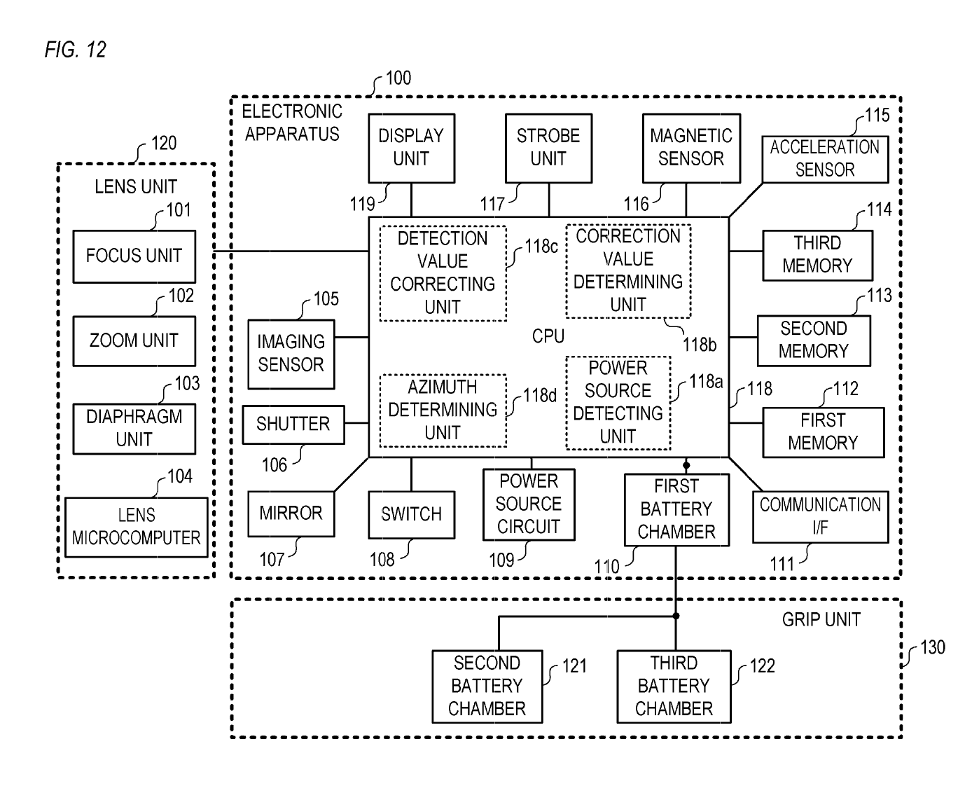

FIGS. 1 and 12 are block diagrams for illustrating examples of the configuration of the electronic apparatus 100 according to the first to third embodiments. In the example shown in FIG. 1, the electronic apparatus 100 is connected to a lens unit 120. In the example shown in FIG. 12, the electronic apparatus 100 is connected to the lens unit 120 and a grip unit 130.

The lens unit 120 is a removable unit including a focus unit 101, a zoom unit 102, a diaphragm unit 103, a lens microcomputer 104, and the like. The lens unit 120 is connected to a predetermined connecting section of the electronic apparatus 100. The lens microcomputer 104 includes a microprocessor for controlling the focus unit 101, the zoom unit 102, the diaphragm unit 103, and the like. The focus unit 101 controls a focus mechanism according to an instruction from the lens microcomputer 104. The zoom unit 102 controls a zoom mechanism according to an instruction from the lens microcomputer 104. The diaphragm unit 103 controls a diaphragm mechanism according to an instruction from the lens microcomputer 104. In the first to third embodiments, the lens unit 120 is the removable unit. However, the lens unit 120 may be changed to a unit configured integrally with the electronic apparatus 100.

The electronic apparatus 100 includes an imaging sensor 105, a shutter mechanism 106, a mirror mechanism 107, a switch 108, a power source circuit 109, a first battery chamber 110, and a communication interface unit 111 (hereinafter, communication I/F 111). The electronic apparatus 100 further includes a first memory 112, a second memory 113, a third memory 114, an acceleration sensor 115, a magnetic sensor 116, a strobe unit 117, a central processing unit (CPU) 118, a display unit 119, and the like.

Any one of a battery, an AC adapter, and the grip unit 130 is connected to the first battery chamber 110 as a power source for the electronic apparatus 100. In the first to third embodiment, in a case where the grip unit 130 is connected to the first battery chamber 110, the battery and the AC adapter cannot be connected to the first battery chamber 110.

The grip unit 130 is a removable unit including a second battery chamber 121, a third battery chamber 122, and the like. The grip unit 130 is connected to the electronic apparatus 100 via the first battery chamber 110. One of the battery and the AC adapter is connected to the second battery chamber 121. One of the battery and the AC adapter is connected to the third battery chamber 122 as well. The battery used in the first to third embodiments is not limited to a battery of one type, and may be a battery of any type. Various batteries such as a lithium ion battery, a nickel hydrogen battery, a dry cell, a fuel battery, and the like can be used. The AC adapter used in the first to third embodiments may be an AC adapter of any type as long as the AC adapter has a function of converting an AC voltage into a predetermined DC voltage. Note that the AC adapter connected to the second battery chamber 121 may be an AC adapter connected to the second battery chamber 121 via a DC coupler. The AC adapter connected to the third battery chamber 122 may be an AC adapter connected to the third battery chamber 122 via a DC coupler.

As explained above, any one of the battery, the AC adapter, and the grip unit 130 is connected to the first battery chamber 110 as the power source for the electronic apparatus 100. Therefore, in a case where the battery is connected to the first battery chamber 110 as the power source for the electronic apparatus 100, a type of the power source connected to the first battery chamber 110 changes according to a type of the battery. In a case where the AC adapter is connected to the first battery chamber 110 as the power source for the electronic apparatus 100, a type of the power source connected to the first battery chamber 110 changes according to a type of the AC adapter. In a case where the grip unit 130 is connected to the first battery chamber 110, a type of the power source connected to the first battery chamber 110 changes according to a type of the power source connected to at least one of the second battery chamber 121 and the third battery chamber 122. Therefore, in the first to third embodiment, power supplies of various types are assumed as the power source connected to the first battery chamber 110.

The CPU 118 is a control unit including a microprocessor for controlling all the components included in the electronic apparatus 100 and the lens unit 120. In a case where the lens unit 120 is connected to the electronic apparatus 100, the CPU 118 and the lens microcomputer 104 are communicably connected, and the CPU 118 can control the lens microcomputer 104. As a result, the CPU 118 can control the lens unit 120. The CPU 118 includes a power source detecting unit 118a, a correction value determining unit 118b, a detection value correcting unit 118c, an azimuth determining unit 118d, and the like. The power source detecting unit 118a, the correction value determining unit 118b, the detection value correcting unit 118c, and the azimuth determining unit 118d are explained below.

The power source circuit 109 supplies electric power supplied from the power source connected to the first battery chamber 110 to the components of the electronic apparatus 100 and to the components of the lens unit 120. The communication I/F 111 is a communication control unit that performs communication with an external apparatus. The display unit 119 can display information (a menu screen, etc.) for a user interface. The display unit 119 can also display an image generated from captured image data captured (imaged) up by the imaging sensor 105. The display unit 119 can also display an image generated from image data stored by the first memory 112. The display unit 119 can also be used as an electronic viewfinder (EVF).

The first memory 112 is a storage medium that stores image data generated by the imaging sensor 105. The first memory 112 may be removable from the electronic apparatus 100. The second memory 113 is a storage medium that stores a computer program to be executed by the CPU 118, i.e., a computer program for controlling the electronic apparatus 100. The information (the menu screen, etc.) for the user interface is also stored in the second memory 113. The third memory 114 is a storage medium that temporarily stores various data. For example, the third memory 114 is used as a work memory of the CPU 118.

The switch 108 is a switch for instructing the electronic apparatus 100 to perform imaging. The imaging sensor 105 is an imaging sensor that converts light made incident via the lens unit 120 into an electric signal and generates captured image data from the electronic signal. The imaging sensor 105 is driven according to an instruction from the CPU 118. As the imaging sensor 105, for example, a CCD or CMOS sensor can be used. The shutter mechanism 106 controls opening and closing of a shutter according to an instruction from the CPU 118. For example, the shutter mechanism 106 controls the opening and closing of the shutter such that light is made incident on the imaging sensor 105 at predetermined timing during imaging. The mirror mechanism 107 controls the direction of a mirror according to an instruction from the CPU 118. For example, the mirror mechanism 107 controls the direction of the mirror to set a route of the light made incident via the lens unit 120 to a desired route. Specifically, the mirror mechanism 107 controls the direction of the mirror to guide the light to the side of a finder during non-imaging and guide the light to the side of the shutter mechanism 106 and the imaging sensor 105 during the imaging. The strobe unit 117 is a light emitting unit that emits light. The light emission of the strobe unit 117 is controlled by the CPU 118. For example, the light emission of the strobe unit 117 is controlled such that the light emission is performed according to necessity during the imaging.

In the first to third embodiments, by the user operates the switch 108, imaging is performed. In a case where the CPU 118 detects that the switch 108 is operated, the CPU 118 instructs the lens microcomputer 104 to execute AF and AE. The lens microcomputer 104 controls the focus unit 101, the zoom unit 102, the diaphragm unit 103, and the like according to the instruction for the execution of the AF and the AE to thereby automatically adjust focus and exposure (an AF process and an AE process). Thereafter, the CPU 118 controls the mirror mechanism 107, the shutter mechanism 106, and the imaging sensor 105 to cause the imaging sensor 105 to generate captured image data. After the AF process and the AE process, in a case where it is determined that an imaging target region is dark, the CPU 118 performs charging control of the strobe unit 117 and causes the strobe unit 117 to emit light at timing for driving the imaging sensor 105.

The magnetic sensor 116 performs a process for detecting terrestrial magnetism (a first detection process). The acceleration sensor 115 performs a process for detecting acceleration applied to the acceleration sensor 115 (a second detection process). In the first to third embodiments, the magnetic sensor 116 and the acceleration sensor 115 are disposed in the vicinity of the first battery chamber 110.

When detecting an azimuth in which a predetermined surface (e.g., an imaging surface) of the electronic apparatus 100 is directed, the CPU 118 drives the magnetic sensor 116 and the acceleration sensor 115, acquires a detection value from the magnetic sensor 116, and acquires a detection value from the acceleration sensor 115 as well. In the following explanation, the detection value of the magnetic sensor 116 is referred to as magnetic detection value and the detection value of the acceleration sensor 115 is referred to as acceleration detection value.

In a case where an instruction for starting the electronic apparatus 100 is input to the CPU 118, the first battery chamber 110 detects a type of a power source connected to the first battery chamber 110 and notifies the power source detecting unit 118a of a result of the detection. In a case where the instruction for starting the electronic apparatus 100 is input to the CPU 118, the second battery chamber 121 also detects a type of a power source connected to the second battery chamber 121 and notifies the power source detecting unit 118a of a result of the detection. In a case where the instruction for starting the electronic apparatus 100 is input to the CPU 118, the third battery chamber 122 also detects a type of a power source connected to the third battery chamber 122 and notifies the power source detecting unit 118a of a result of the detection. For example, the electronic apparatus 100 inputs an instruction for starting the electronic apparatus 100 to the CPU 118 in a case there a power switch of the electronic apparatus 100 is pressed. However, timings when the power source detecting unit 118a acquires the detection results respectively from the first battery chamber 110, the second battery chamber 121, and the third battery chamber 122 are not limited to the timings explained above.

The power source detecting unit 118a determines, on the basis of the detection results respectively notified from the first battery chamber 110, the second battery chamber 121, and the third battery chamber 122, the type of the power source connected to the first battery chamber 110. Naturally, the power source detecting unit 118a can also determine, on the basis of the detection results respectively notified from the first battery chamber 110, the second battery chamber 121, and the third battery chamber 122, whether the grip unit 130 is connected to the electronic apparatus 100.

Note that, the first battery chamber 110 can use various methods as a method of detecting the type of the power source connected to the first battery chamber 110. The second battery chamber 121 can also use various methods as a method of detecting the type of the power source connected to the second battery chamber 121. The third battery chamber 122 can also use various methods as a method of detecting the type of the power source connected to the third battery chamber 122. For example, the type of the power source may be detected by a mechanical method such as a switch. The type of the power source may be detected according to a different resistance value for each of power sources. The type of the power source may be detected by accessing a memory included in the power source. The type of the power source may be detected by communicating with the power source.

In the first embodiment, the electronic apparatus 100 has operation modes. One of the operation modes is, for example, a still image shooting mode for capturing a still image. One of the operation modes is, for example, a moving image shooting mode for capturing a moving image. One of the operation modes is a live view mode (hereinafter referred to as LV mode) in which the display unit 119 is used as an electronic viewfinder. One of the operation modes is a TFT ON mode for displaying captured image data on the display unit 119.

The CPU 118 corrects a magnetic detection value of the magnetic sensor 116 on the basis of a combination of a selected operation mode and the type of the power source connected to the first battery chamber 110. Consequently, the magnetic detection value is corrected such that a change in the magnetic detection value due to the power source connected to the first battery chamber 110 is reduced. This correction process is performed using the correction value determining unit 118b and the detection value correcting unit 118c. Details of the correction value determining unit 118b and the detection value correcting unit 118c are explained below. Note that the magnetic detection value of the magnetic sensor 116 may be corrected on the basis of the type of the power source connected to the first battery chamber 110 without taking into account the selected operation mode.

The azimuth determining unit 118d determines, on the basis of the magnetic detection value after the correction and the acceleration detection value of the acceleration sensor 115, an azimuth in which a predetermined surface (e.g., an imaging surface) of the electronic apparatus 100 is directed. In the first embodiment, alight receiving surface of the imaging sensor 105 is referred to as imaging surface and an azimuth in which the imaging surface is directed is referred to as imaging azimuth. Note that the imaging azimuth may be determined according to any method as long as the imaging azimuth can be accurately determined using the magnetic detection value after the correction. For example, the imaging azimuth may be determined according to a method with which the imaging azimuth can be accurately determined using the magnetic detection value after the correction and detection values other than the acceleration detection value.

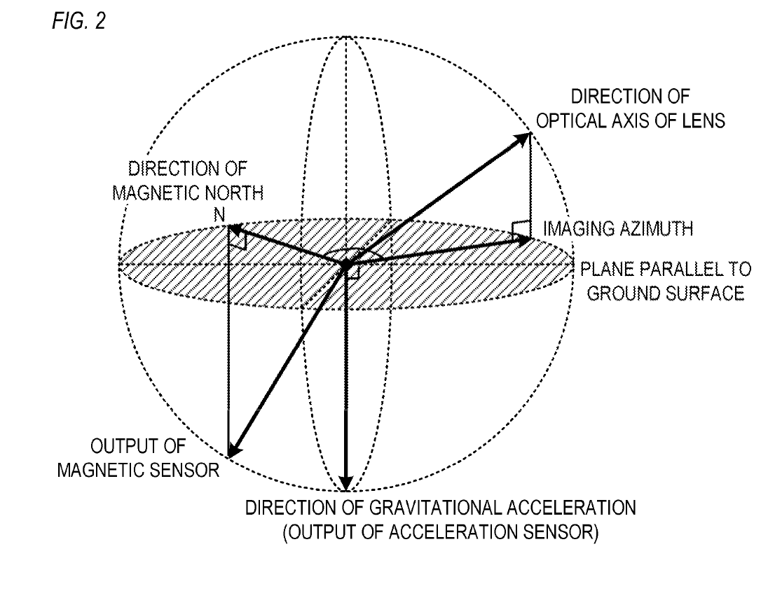

FIG. 2 is a schematic diagram showing an example of a determination method for the imaging azimuth.

The magnetic sensor 116 can three-dimensionally detect a magnetic field. The acceleration sensor 115 can three-dimensionally detect acceleration. A magnetic detection value of the magnetic sensor 116 includes a combination (a three-dimensional vector) of three values (an x value, a y value, and a z value) corresponding to three axial directions. The x value is a value corresponding to an x-axis direction. The y value is a value corresponding to a y-axis direction, and the z value is a value corresponding to a z-axis direction. An acceleration detection value of the acceleration sensor 115 also includes a combination (a three-dimensional vector) of three values (an x value, a y value, and a z value) corresponding to the three axial directions. The values in the three directions included in the acceleration detection value of the acceleration sensor 115 are respectively multi-bit values with signs.

In the first embodiment, the direction of acceleration represented by the acceleration detection value of the acceleration sensor 115 is detected as the direction of the gravitational acceleration. A direction obtained by projecting the direction of a magnetic field represented by the magnetic detection value after correction on a plane perpendicular to the direction of the gravitational acceleration (a plane parallel to the ground surface) is detected as the direction of the magnetic north of the terrestrial magnetism. Specifically, a vector represented by the magnetic detection value after the correction is divided into a vector in the direction of the gravitational acceleration (a first vector) and a vector in the direction perpendicular to the direction of the gravitational acceleration (a second vector). The direction of the second vector is detected as the direction of the magnetic north of the terrestrial magnetism.

A direction obtained by projecting the direction of the optical axis of the lens unit 120 (equivalent to the direction in which the imaging surface is directed) on a plane perpendicular to the direction of the gravitational acceleration is detected as an imaging direction. Specifically, a vector representing the direction of the optical axis is divided into a vector in the direction of the gravitational acceleration (a third vector) and a vector in the direction perpendicular to the direction of the gravitational acceleration (a fourth vector). The direction of the fourth vector is detected as the imaging direction.

The imaging azimuth is determined on the basis of the direction of the magnetic north and the imaging direction. A relation between the direction of the magnetic north and the imaging direction can be represented by, for example, an angle between the direction of the magnetic north and the imaging direction. Specifically, the relation between the direction of the magnetic north and the imaging direction can be represented by an angle between the second vector and the fourth vector.

Note that the imaging azimuth may be detected at any timing. For example, the imaging azimuth may be detected during the imaging. Information indicating the imaging azimuth of the captured image data may be stored in the first memory 112 together with the captured image data. In a case where an image corresponding to the captured image data is displayed, the information indicating the imaging azimuth of the captured image data can be displayed together with the image. Consequently, it is possible to inform the user of the imaging azimuth of the captured image data. The captured image data may be a still image or may be a moving image. In a case where the moving image is captured, it is desirable that the imaging azimuth is detected for each of N (N is an integer equal to or larger than 1) frames. Consequently, it is possible to notify, for each of N frames, the user of the information indicating the imaging azimuth. A process for detecting the imaging azimuth may be always repeatedly executed. Information indicating the latest imaging azimuth may be displayed on the display unit 119 on a real-time basis. Consequently, it is possible to notify the user of the information indicating the latest imaging azimuth on a real-time basis.

In a period in which the imaging is not performed, an image indicating the latest imaging range (an object) may be further displayed on the display unit 119. That is, in the period in which the imaging is not performed, the display unit 119 may be used as an electronic viewfinder.

In a case where an imaging position (the position of the electronic apparatus 100) is detected using a GPS or the like, the direction of the magnetic north may be used as the direction of the due north.

The correction value determining unit 118b and the detection value correcting unit 118c are explained.

It is desirable that a magnetic detection value representing the terrestrial magnetism is obtained as the magnetic detection value of the magnetic sensor 116. However, a magnetic field detected by the magnetic sensor 116 changes according to various factors. In the magnetic sensor 116, the magnetic detection value changing according to the various factors is obtained. The change in the magnetic detection value due to the various factors can also be referred to as “noise of the magnetic detection value” or “an error of the magnetic detection value”.

For example, a motor for driving the shutter mechanism 106 and the mirror mechanism 107 is provided on the inside of the electronic apparatus 100. A permanent magnet which always generates lines of magnetic force is provided on the inside of the motor. A magnetic field of the permanent magnet changes the magnetic detection value of the magnetic sensor 116. That is, the magnetic field of the permanent magnet adversely affects the magnetic detection value of the magnetic sensor 116. A current magnetic field corresponding to the operating current of the electronic apparatus 100 is generated in the electronic apparatus 100. The current magnetic field also adversely affects the magnetic detection value of the magnetic sensor 116. The magnetic detection value of the magnetic sensor 116 sometimes changes according to a change in the selected operation mode. Specifically, the operating current is sometimes different among the operation modes. Therefore, by switching the selected operation mode to another operation mode, the operating current flowing to the electronic apparatus 100 sometimes changes. The current magnetic field generated by the operating current also sometimes changes. The magnetic field shifts the magnetic field detected by the magnetic sensor 116 and adversely affects the magnetic detection value of the magnetic sensor 116.

Therefore, in the first to third embodiments, the magnetic detection value is corrected using the correction value determining unit 118b and the detection value correcting unit 118c such that a change (a first change) in the magnetic detection value due to the shift of the magnetic field is reduced. Specifically, an offset value (a first correction value) equivalent to the magnetic field adversely affecting the magnetic detection value of the magnetic sensor 116 is subtracted from the magnetic detection value of the magnetic sensor 116. Consequently, it is possible to reduce a change in the magnetic detection value of the magnetic sensor 116 due to a magnetic field generated from a member.

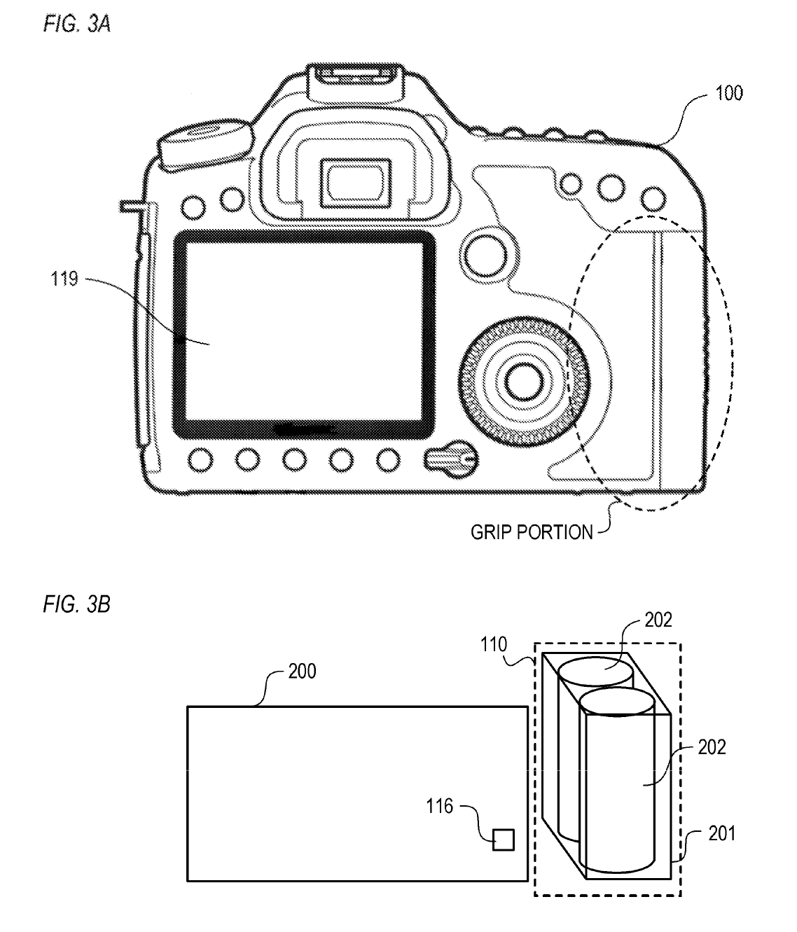

FIG. 3A is an external view for illustrating an example of the exterior of the electronic apparatus 100. FIG. 3B is a diagram for illustrating an example of the internal structure of the electronic apparatus 100 shown in FIG. 3A. In the examples shown in FIGS. 3A and 3B, the first battery chamber 110 is provided in a grip portion. A battery 201 is connected to the first battery chamber 110.

A main substrate 200 is a main substrate on which a large number of functional units of the electronic apparatus 100 are disposed. The main substrate 200 is provided to occupy the most of the rear surface of the electronic apparatus 100. The CPU 118, the imaging sensor 105, a driving circuit for the imaging sensor 105, and the like are provided in the center portion of the main substrate 200. The imaging sensor 105, the driving circuit for the imaging sensor 105, and the like are likely to adversely affect the magnetic detection value of the magnetic sensor 116. Therefore, the magnetic sensor 116 is disposed in a position apart from these members and in the vicinity of the first battery chamber 110 such that the adverse effect by the members is reduced. In the example shown in FIG. 3B, the magnetic sensor 116 is provided in a lower right portion of the main substrate 200. Note that, as explained above, other than the battery 201, the AC adapter can be connected to the first battery chamber 110. The grip unit 130 can also be connected to the first battery chamber 110.

On the inside of the battery 201, for example, two cylindrical battery cells 202 are provided. Armor members of the battery cells 202 are configured by a magnetic body such as iron or stainless steel. The magnetic body causes distortion in a magnetic field around the magnetic body. A phenomenon in which the magnetic field is distorted by the magnetic body is called “soft iron effect”. The soft ion effect adversely affects the magnetic detection value of the magnetic sensor 116. The soft iron effect distorts the magnetic field detected by the magnetic sensor 116. Consequently, it is likely that the direction of the magnetic field detected by the magnetic sensor 116 changes.

Therefore, in the first to third embodiments, the magnetic detection value is corrected using the correction value determining unit 118b and the detection value correcting unit 118c such that a change (a second change) in the magnetic detection value due to the distortion of the magnetic field is reduced. Specifically, the values (the x value, the y value, and the z value) in the three directions included in the magnetic detection value of the magnetic sensor 116 are individually corrected. More specifically, the magnetic detection value of the magnetic sensor 116 is multiplied with a conversion matrix (a second correction value) for reducing the change in the magnetic field due to the soft iron effect. Consequently, it is possible to reduce the change in the magnetic detection value of the magnetic sensor 116 due to the soft ion effect.

The distortion of the magnetic field by the soft iron effect depends on a type of the magnetic body, the size of the magnetic body, the shape of the magnetic body, the distance from the magnetic sensor 116 to the magnetic body, and the like. Therefore, by changing the type of the power source connected to the first battery chamber 110, the distortion of the magnetic field due to the soft iron effect also changes. Therefore, in the first embodiment, the conversion matrix (the second correction value) is changed according to the type of the power source determined by the power source detecting unit 118a.

The magnetic field causing the first change is also distorted by the soft iron effect. Therefore, by changing the type of the power source connected to the first battery chamber 110, a shift amount of the magnetic field detected by the magnetic sensor 116 also changes. Therefore, in the first embodiment, the offset value (the first correction value) equivalent to the magnetic field adversely affecting the magnetic detection value of the magnetic sensor 116 is switched according to the type of the power source determined by the power source detecting unit 118a.

Note that, in a case where a member having a large volume is provided near the magnetic sensor 116, since the influence of the member on the soft iron effect is extremely large, there is no problem in neglecting the influence of other members on the soft iron effect. In the example shown in FIG. 3B, the first battery chamber 110 is provided near the magnetic sensor 116. Therefore, the influence of the power source connected to the first battery chamber 110 on the soft iron effect is large. There is no problem in neglecting the influence of the other members on the soft iron effect.

The correction value determining unit 118b determines, on the basis of the selected operation mode and the type of the power source connected to the first battery chamber 110, the first correction value (the offset value) and the second correction value (the conversion matrix) for correcting the magnetic detection value of the magnetic sensor 116. The detection value correcting unit 118c corrects the magnetic detection value of the magnetic sensor 116 on the basis of the first correction value (the offset value) and the second correction value (the conversion matrix) determined by the correction value determining unit 118b.

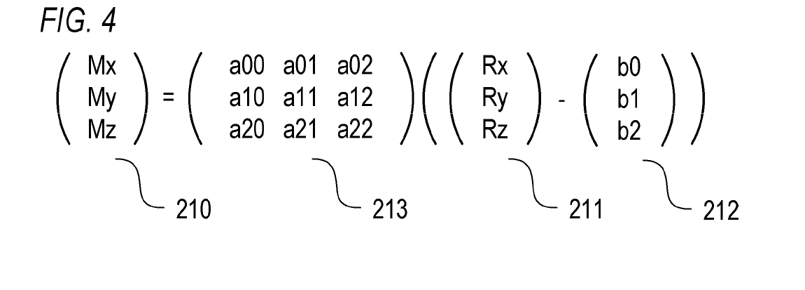

In the first embodiment, the detection value correcting unit 118c corrects the magnetic detection value of the magnetic sensor 116 using a formula (a correction formula) shown in FIG. 4.

In FIG. 4, reference numeral 211 denotes the magnetic detection value before the correction and reference numeral 210 denotes the magnetic detection value after the correction. The magnetic detection value 210 after the correction is a matrix of three rows and one column having the three detection values (the x value, the y value, and the z value) corresponding to the three axial directions. The magnetic detection value 211 before the correction is also a matrix of three rows and one column having the three detection values (the x value, the y value, and the z value) corresponding to the three axial directions.

In FIG. 4, reference numeral 212 denotes the offset value (the first correction value) determined by the correction value determining unit 118b and reference numeral 213 denotes the conversion matrix (the second correction value) determined by the correction value determining unit 118b. The offset value 212 is a matrix of three rows and one column having the three values (the x value, the y value, and the z value) corresponding to the three axial directions. The conversion matrix 213 determined by the correction value determining unit 118b is a matrix of three rows and three columns.

As shown in FIG. 4, in the first embodiment, the offset value 212 is subtracted from the magnetic detection value 211 before the correction. A result of the subtraction (a vector of three rows and one column) is multiplied with the conversion matrix 213 determined by the correction value determining unit 118b. Consequently, the magnetic detection value 210 after the correction is calculated. By multiplying the subtraction result with the conversion matrix 213 determined by the correction value determining unit 118b, it is possible to rotate the vector represented by the subtraction result and expand and reduce the vector represented by the subtraction result.

If appropriate values are used as the offset value 212 determined by the correction value determining unit 118b and the conversion matrix 213 determined by the correction value determining unit 118b, it is possible to obtain, as the magnetic detection value 210 after the correction, a value well representing the terrestrial magnetism. As a result, it is possible to highly accurately detect the imaging azimuth.

In the first embodiment, a combination of the type of the power source connected to the first battery chamber 110 and the selected operation mode and a correspondence relation between the first correction value (the offset value) and the second correction value (the conversion matrix) are decided in advance. Specifically, information indicating the correspondence relation is stored in the second memory 113 (or the first memory 112) in advance. As the information indicating the correspondence relation, a function and a table can be used. The correction value determining unit 118b reads out the information indicating the correspondence relation from the second memory 113 (or the first memory 112). The correction value determining unit 118b determines, on the basis of the correspondence relation, the first correction value (the offset value) and the second correction value (the conversion matrix) corresponding to the combination of the selected operation mode and the type of the power source connected to the first battery chamber 110.

Note that the first correction value (the offset value) and the second correction value (the conversion matrix) for correcting the magnetic detection value of the magnetic sensor 116 may be determined on the basis of the type of the power source connected to the first battery chamber 110 without taking into account the selected operation mode. Specifically, a correspondence relation between the type of the power source connected to the first battery chamber 110 and the first correction value (the offset value) and the second correction value (the conversion matrix) may be decided in advance. The first correction value (the offset value) and the second correction value (the conversion matrix) corresponding to the type of the power source connected to the first battery chamber 110 may be determined on the basis of the correspondence relation.

Since the soft iron effect depends on the shape and the size of a member, it is difficult to calculate the first correction value (the offset value) and the second correction value (the conversion matrix) on a real-time basis. However, the first correction value (the offset value) and the second correction value (the conversion matrix) can be determined in advance. For example, the conversion matrix only has to be determined in advance for each type of the power source connected to the first battery chamber 110. Specifically, it only has to that the soft iron effect is measured in a state in which each power source is connected to the first battery chamber 110, and the conversion matrix is highly accurately determined on the basis of a result of the measurement. Consequently, it is possible to prepare in advance a different appropriate conversion matrix for each type of the power source connected to the first battery chamber 110.

Like the conversion matrix, the offset value can be determined in advance for each type of the power source connected to the first battery chamber 110. The shift amount of the magnetic field detected by the magnetic sensor 116 depends on the selected operation mode as well. Therefore, it is desirable to determine an appropriate offset value for each combination of the type of the power source connected to the first battery chamber 110 and the selected operation mode. The shift amount of the magnetic field detected by the magnetic sensor 116 has an individual difference of the electronic apparatus 100. Therefore, it is desirable to determine the offset value using the electronic apparatus 100.

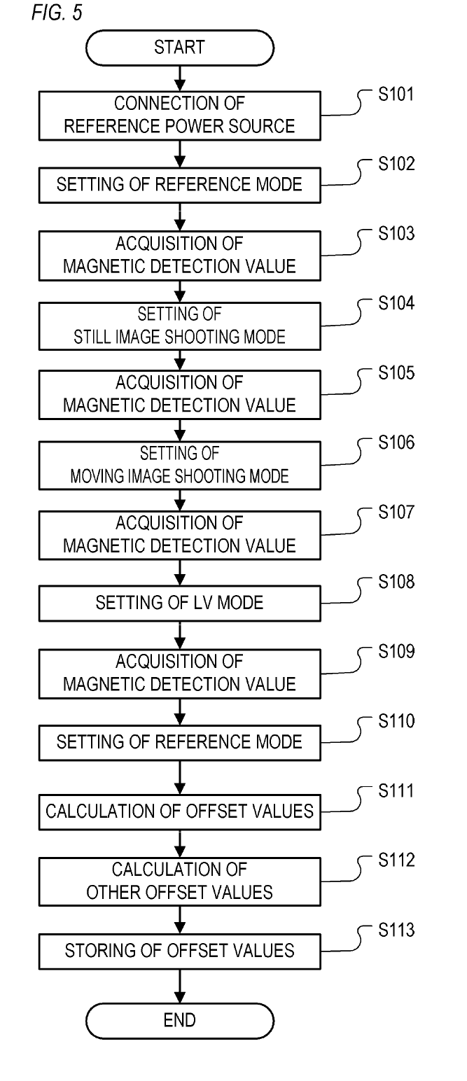

FIG. 5 is a flowchart for illustrating an example of a flow of a process in which the electronic apparatus 100 determines an offset value for each type of a battery (an offset value determination process). The process of the flowchart of FIG. 5 is performed, for example, during manufacturing or during shipment of the electronic apparatus 100.

First, in 5101, after connecting a reference power source to the first battery chamber 110, an operator instructs the electronic apparatus 100 to start the offset value determination process. The reference power source may be the battery connected to the first battery chamber 110 or may be the AC adapter connected to the first battery chamber 110.

In S102, the CPU 118 sets a state of the electronic apparatus 100 to a reference state (e.g., an idle state). In other words, the operation mode of the electronic apparatus 100 is set to a reference mode. Note that the reference state is not limited to the idle state.

In S103, the CPU 118 acquires a magnetic detection value in the idle state from the magnetic sensor 116. Note that the magnetic detection value may be sampled a plurality of times and an average of a plurality of sampled magnetic detection values may be acquired. Consequently, it is possible to obtain a magnetic detection value (an average) from which fine noise due to the power source circuit 109 and the like is removed.

In S104, the CPU 118 sets the operation mode of the electronic apparatus 100 to the still image shooting mode. In S105, the CPU 118 acquires, from the magnetic sensor 116, a magnetic detection value at the time when the operation mode of the electronic apparatus 100 is set to the still image shooting mode.

In S106, the CPU 118 sets the operation mode of the electronic apparatus 100 to the moving image shooting mode. In S107, the CPU 118 acquires, from the magnetic sensor 116, a magnetic detection value at the time when the operation mode of the electronic apparatus 100 is set to the moving image shooting mode.

In S108, the CPU 118 sets the operation mode of the electronic apparatus 100 to the LV mode. In S109, the CPU 118 acquires, from the magnetic sensor 116, a magnetic detection value at the time when the operation mode of the electronic apparatus 100 is set to the LV mode.

In S110, the CPU 118 returns the state of the electronic apparatus 100 to the reference state (e.g., the idle state). Note that the process in S110 may be omitted.

In S111, the CPU 118 calculates, on the basis of a difference between the magnetic detection value obtained in S103 and the magnetic detection value obtained in S105, an offset value corresponding to a combination of the reference power source and the still image shooting mode. The CPU 118 calculates, on the basis of the magnetic detection value obtained in S103 and the magnetic detection value obtained in S107, an offset value corresponding to a combination of the reference power source and the moving image shooting mode. The CPU 118 calculates, on the basis of a difference between the magnetic detection value obtained in S103 and the magnetic detection value obtained in S109, an offset value corresponding to a combination of the reference power source and the LV mode.

In S112, the CPU 118 calculates, on the basis of the offset values calculated in S111, offset values corresponding to combinations of the other all types of the power sources and the operation modes (a conversion process). Consequently, it is possible to reduce a work man-hour and a work time of the operator. Note that, in FIG. 5, the offset values corresponding to the combinations of the one type of the power source and the operation modes are calculated using the measurement results of the magnetic detection values. The offset values corresponding to the combinations of the other all types of the batteries and the operation modes are calculated. However, calculation of offset values is not limited to this. Offset values corresponding to all or a part of the combinations of the other all types of the power sources and the operation modes may be calculated using the measurement results of the magnetic detection values.

In S113, the CPU 118 stores all the offset values calculated in S111 and S112 in the second memory 113 (or the first memory 112).

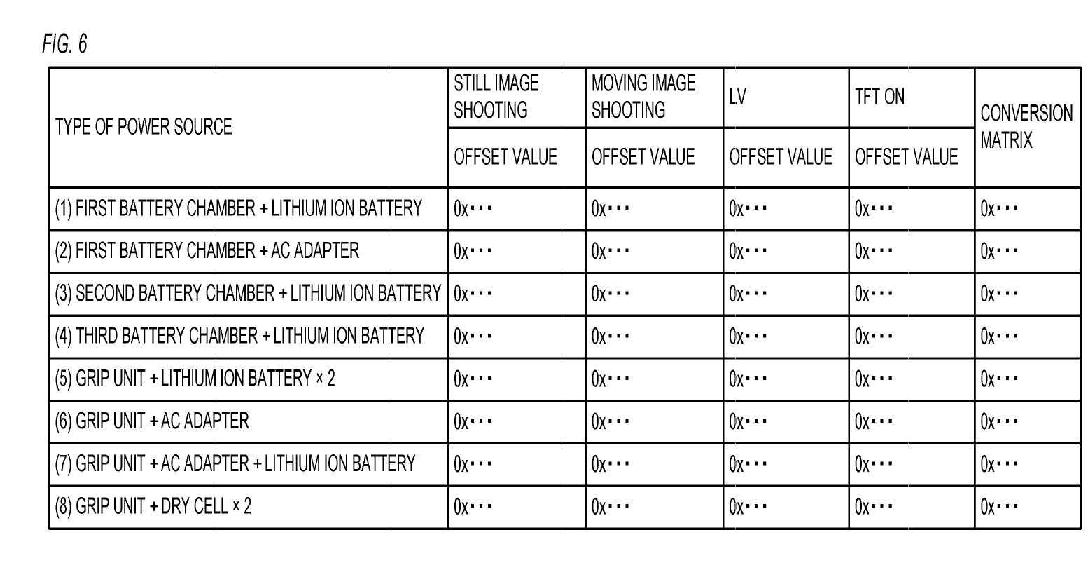

FIG. 6 is a diagram for illustrating an example of power source information stored in the second memory 113 (or the first memory 112) in advance. In the example shown in FIG. 6, different eight power source information are assumed according to the types of the power sources connectable to the first battery chamber 110. Each power source information includes first correction values (offset values) prepared for each of different power sources and a second correction values (conversion matrix).

(1) First power source information is power source information used in a case where a lithium ion battery connected to the first battery chamber 110 is the power source connected to the first battery chamber 110. The first power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(2) Second power source information is power source information used in a case where an AC adapter connected to the first battery chamber 110 is the power source connected to the first battery chamber 110. The second power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(3) Third power source information is power source information used in a case where a lithium ion battery connected to the second battery chamber 121 is the power source connected to the first battery chamber 110. The third power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(4) Fourth power source information is power source information used in a case where a lithium ion battery connected to the third battery chamber 122 is the power source connected to the first battery chamber 110. The fourth power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(5) Fifth power source information is power source information used in a case where lithium ion batteries connected to both of the second battery chamber 121 and the third battery chamber 122 are the power sources connected to the first battery chamber 110. The fifth power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(6) Sixth power source information is power source information used in a case where an AC adapter connected to at least one of the second battery chamber 121 and the third battery chamber 122 is the power source connected to the first battery chamber 110. The sixth power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(7) Seventh power source information is power source information used in a case where an AC adapter connected to one of the second battery chamber 121 and the third battery chamber 122 and a lithium ion battery connected to the other are the power sources connected to the first battery chamber 110. The seventh power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

(8) Eighth power source information is power source information used in a case where dry cells connected to both of the second battery chamber 121 and the third battery chamber 122 are the power sources connected to the first battery chamber 110. The eighth power source information includes first correction values (offset values) and one second correction value (conversion matrix) suitable for this case. As the first correction values (offset values), appropriate values are prepared for each of the four operation modes (the still image shooting mode, the moving image shooting mode, the LV mode, and the TFT ON mode).

Note that the power source information stored in the second memory 113 (or the first memory 112) in advance are not limited to the eight power source information explained above. The operation modes of the electronic apparatus 100 are not limited to the four operation modes explained above. The number of assumed power source information may be larger than or smaller than eight. The number of assumed operation modes may be larger than or smaller than four.

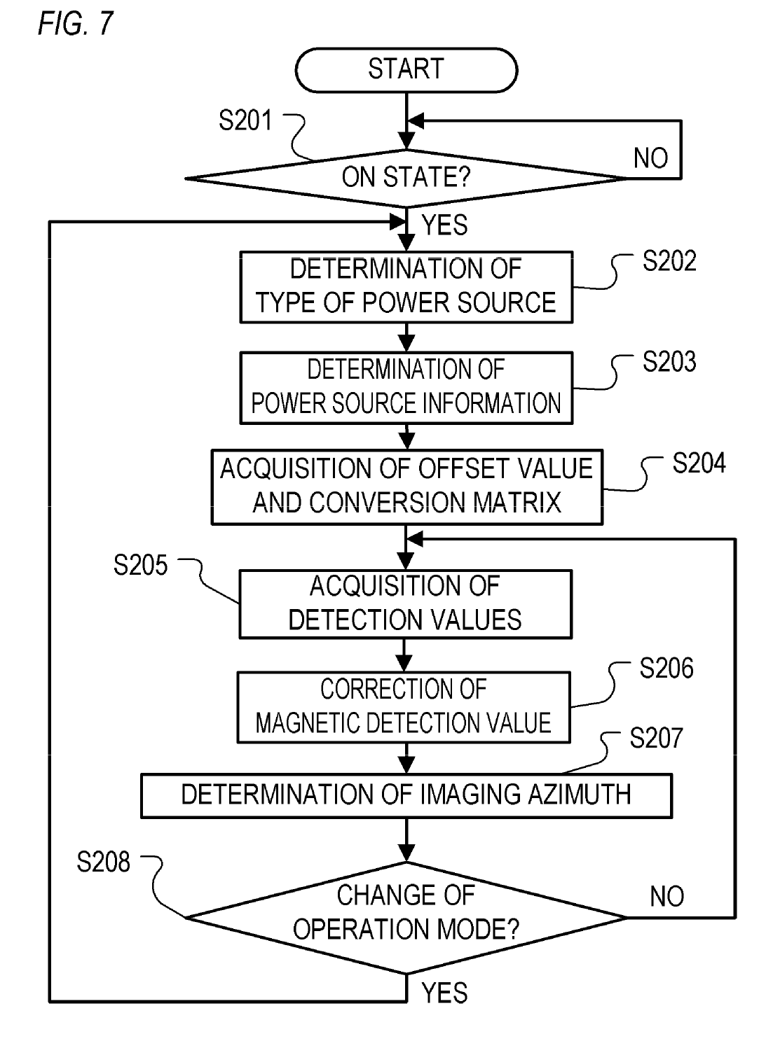

FIG. 7 is a flowchart for illustrating an example of a flow of the operation of the electronic apparatus 100. Specifically, FIG. 7 is a flowchart for illustrating an example of a flow of operation from the start of the electronic apparatus 100 to determination of an imaging azimuth.

First, in S201, the CPU 118 determines whether a state of the power switch is switched to an ON state. By switching the state of the power switch to the ON state, the electronic apparatus 100 starts and the CPU 118 proceeds from S201 to S202.

In S202, the power source detecting unit 118a determines a type of the power source connected to the first battery chamber 110.

In S203, the CPU 118 determines power source information corresponding to the type of the power source connected to the first battery chamber 110. For example, one of the eight power source information shown in FIG. 6 is determined by the CPU 118 as the power source information corresponding to the type of the power source connected to the first battery chamber 110.

In S204, the correction value determining unit 118b reads out, from the second memory 113 (or the first memory 112), the offset value (the first correction value) and the conversion matrix (the second correction value) included in the power source information determined in S203. The offset value (the first correction value) readout from the second memory 113 (or the first memory 112) corresponds to the selected operation mode.

In S205, the CPU 118 drives the acceleration sensor 115 and the magnetic sensor 116, acquires an acceleration detection value from the acceleration sensor 115, and acquires a magnetic detection value from the magnetic sensor 116.

In S206, the detection value correcting unit 118c corrects the magnetic detection value acquired in S206 using the offset value (the first correction value) and the conversion matrix (the second correction value) acquired in S204.

In S207, the azimuth determining unit 118d determines an imaging azimuth using the magnetic detection value after the correction and the acceleration detection value acquired in S206. In a case where the selected operation mode is the still image shooting mode or the moving image shooting mode, the CPU 118 stores information indicating the imaging azimuth determined in S207 in the first memory 112 together with captured image data.

In S208, the CPU 118 determines whether user operation for changing the selected operation mode to another operation mode is performed. In a case where the user operation for changing the selected operation mode to another operation mode is not performed, the CPU 118 returns from S208 to S207 in order to determine an imaging azimuth again. In a case where the user operation for changing the selected operation mode to another operation mode is performed, the CPU 118 returns from S208 to S202.

As explained above, according to the first embodiment, the magnetic detection value of the magnetic sensor 116 is corrected on the basis of a combination of the type of the power source connected to the first battery chamber 110 and the operation mode of the electronic apparatus 100. The imaging azimuth is determined on the basis of the magnetic detection value after the correction and the acceleration detection value of the acceleration sensor. Consequently, it is possible to suppress the determined azimuth from changing depending on a change of the power source and highly accurately determine the imaging azimuth.

### Second Embodiment

The electronic apparatus 100 and a control method for the electronic apparatus 100 according to a second embodiment are explained below.

In the first embodiment, the example is explained in which the magnetic detection value of the magnetic sensor 116 is corrected on the basis of the type of the power source connected to the first battery chamber 110 and the selected operation mode.

However, by a change in a state of the power source connected to the first battery chamber 110, the shift amount of the magnetic field detected by the magnetic sensor 116 and a degree of the soft iron effect sometimes change. In a case where the power source connected to the first battery chamber 110 is a battery, the state of the power source include a residual capacity of the battery, a voltage of the battery, a deterioration degree of the battery, and the like.

Specifically, by consuming electric power retained in the battery, a chemical change occurs on the inside of the battery and the composition of substances on the inside of the battery gradually changes. By a change of the substances on the inside of the battery, the degree of the soft iron effect sometimes changes. In a case where the battery is deteriorated, similarly, the degree of the soft iron effect sometimes changes.

In a case where the power source circuit 109 has a circuit configuration including a switching power source, if it is attempted to realize the same operation before and after a change in the voltage of the battery, an electric current flowing to the battery changes. Therefore, by a change in the voltage of the battery, the shift amount of the magnetic field detected by the magnetic sensor 116 also changes.

Therefore, in the second embodiment, an example is explained in which a magnetic detection value is corrected taking into account the state of the power source connected to the first battery chamber 110. In a case where the power source connected to the first battery chamber 110 is a battery, as the state of the power source, all or at least one of a residual capacity of the battery, a voltage of the battery, and a deterioration degree of the battery is taken into account.

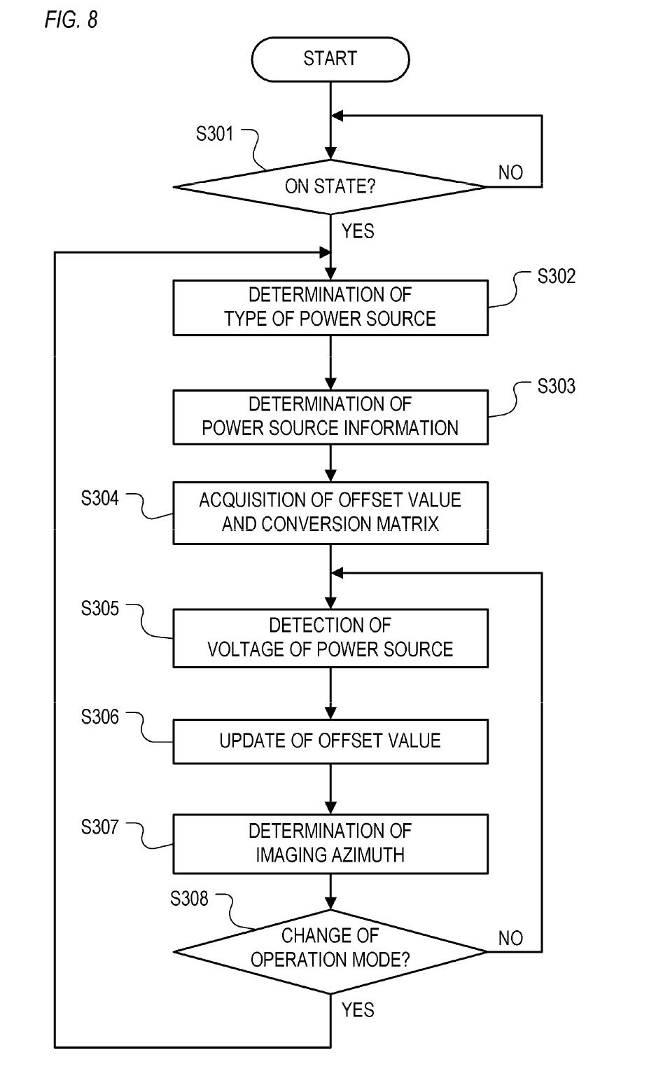

FIG. 8 is a flowchart for illustrating an example of the operation of the electronic apparatus 100 according to the second embodiment. FIG. 8 is a flowchart for illustrating an example in which the power source is the battery and the residual capacity of the battery is taken into account as the state of the power source.

First, in S301, the CPU 118 determines whether a state of the power switch is switched to an ON state. By switching the state of the power switch to the ON state, the electronic apparatus 100 starts and the CPU 118 proceeds from S301 to S302.

In S302, the power source detecting unit 118a determines a type of the power source connected to the first battery chamber 110.

In S303, the CPU 118 determines power source information corresponding to the type of the power source connected to the first battery chamber 110. For example, one of the eight power source information shown in FIG. 6 is determined by the CPU 118 as the power source information corresponding to the type of the power source connected to the first battery chamber 110.

In S304, the correction value determining unit 118b reads out, from the second memory 113 (or the first memory 112), the offset value (the first correction value) and the conversion matrix (the second correction value) included in the power source information determined in S303. The offset value (the first correction value) read out from the second memory 113 (or the first memory 112) corresponds to the selected operation mode.

In S305, the CPU 118 detects a state of the power source (e.g., a voltage of the power source) connected to the first battery chamber 110. In a case where the power source connected to the first battery chamber 110 is a battery, the voltage of the power source connected to the first battery chamber 110 is equivalent to a residual capacity of the battery.

In S306, the correction value determining unit 118b updates, on the basis of a detection result in S305, the offset value (the first correction value) acquired in S304.

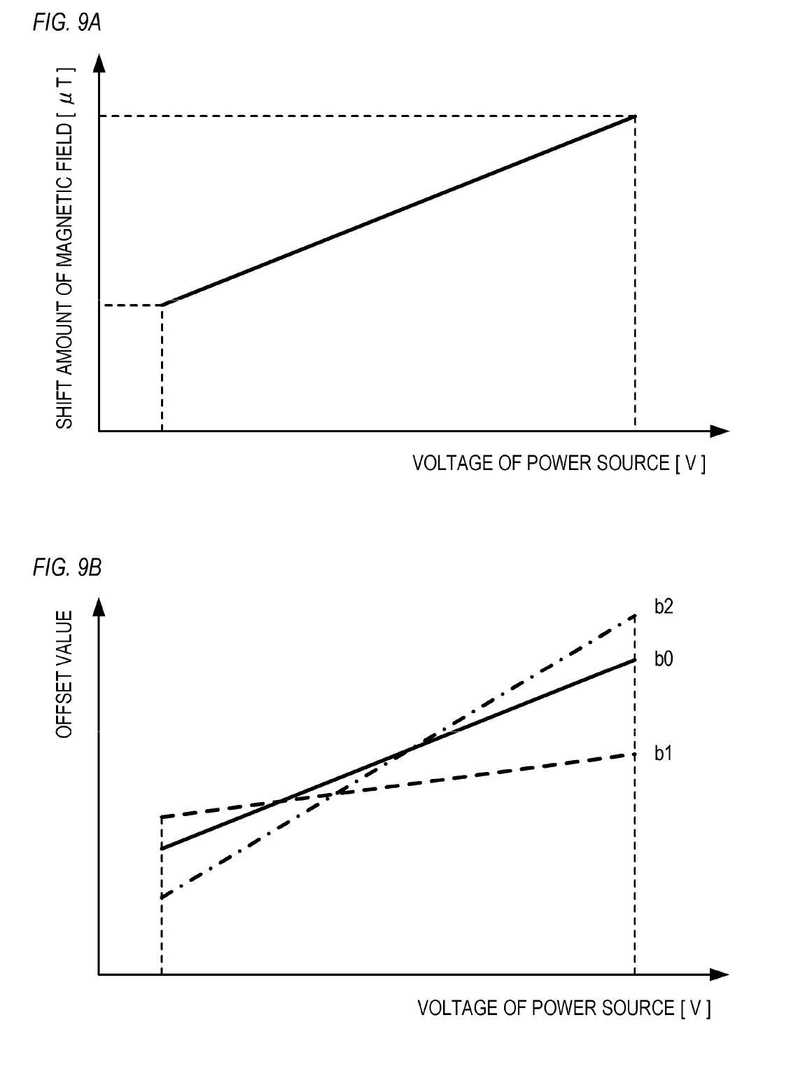

FIG. 9A is a diagram for illustrating an example of a correspondence relation (a first correspondence relation) between the voltage of the power source connected to the first battery chamber 110 and the shift amount of the magnetic field detected by the magnetic sensor 116. As shown in FIG. 9A, by a change in the voltage of the power source connected to the first battery chamber 110, the shift amount also changes. The correspondence relation between the voltage and the shift amount depends on a type and a connection method of the power source connected to the first battery chamber 110.

FIG. 9B is a diagram for illustrating an example of a correspondence relation (a second correspondence relation) between the voltage of the power source connected to the first battery chamber 110 and an offset value that should be used. In FIG. 9B, the correspondence relation between the voltage and the offset value is shown for each of three power sources b0 to b2. In the second embodiment, information representing the correspondence relation between the voltage and the offset value is prepared in the second memory 113 (or the first memory 112) in advance for each combination of the type and the connection method of the power source connected to the first battery chamber 110.

Note that, in a case where the power source connected to the first battery chamber 110 is an AC adapter, usually, the state of the power source (the voltage of the power source) does not change with time. Therefore, in a case where the power source connected to the first battery chamber 110 is the AC adapter, the processes in S305 and S306 may be omitted. In a case where the power source connected to the first battery chamber 110 is the battery, it is highly likely that the state of the power source (the voltage of the power source) changes with time. Therefore, in a case where the power source connected to the first battery chamber 110 is the battery, it is desirable to perform the processes in S305 and S306. In a case where it is likely that the state of the power source changes with time, it is necessary to perform correction according to the change in the power source state.

In S307, the CPU 118 drives the acceleration sensor 115 and the magnetic sensor 116, acquires an acceleration detection value from the acceleration sensor 115, and acquires a magnetic detection value from the magnetic sensor 116. The detection value correcting unit 118c corrects, using the conversion matrix (the second correction value) acquired in S304 and the offset value (the first correction information) updated in S306, the magnetic detection value acquired from the magnetic sensor 116. After the magnetic detection value acquired from the magnetic sensor 116 is corrected, the azimuth determining unit 118d determines an imaging azimuth using the magnetic detection value after the correction and the acceleration detection value acquired in S307. In a case where the selected operation mode is the still image shooting mode or the moving image shooting mode, the CPU 118 stores information indicating the imaging azimuth determined in S307 in the first memory 112 together with captured image data.

In S308, the CPU 118 determines whether user operation for changing the selected operation mode to another operation mode is performed. In a case where the user operation for changing the selected operation mode to another operation mode is not performed, the CPU 118 returns from S308 to S305 in order to determine an imaging azimuth again. In a case where the user operation for changing the selected operation mode to another operation mode is performed, the CPU 118 returns from S308 to S302.

As explained above, according to the second embodiment, the magnetic detection value is corrected taking into account the state of the power source connected to the first battery chamber 110. Consequently, it is possible to more highly accurately determine an imaging azimuth than in the first embodiment.

Note that, in the second embodiment, the example is explained in which, in S305 in FIG. 8, the voltage of the power source is detected as the state of the power source connected to the first battery chamber 110. However, the process in S305 is not limited to this. For example, in S305, a residual capacity of the power source and a deterioration degree of the power source may be detected as the state of the power source connected to the first battery chamber 110. The residual capacity of the battery, the voltage of the battery, the deterioration degree of the battery, and the like can be determined on the basis of, for example, a measurement result of a timer that measures a driving time of the electronic apparatus 100 for each operation mode. The voltage of the battery can also be measured using a voltmeter.

Note that, in the second embodiment, the example is explained in which the offset value is updated in S306 in FIG. 8. However, the process in S306 is not limited to this. For example, the conversion matrix (the second correction value) may be updated on the basis of the state of the power source connected to the first battery chamber 110. For example, both of the offset value (the first correction value) and the conversion matrix (the second correction value) may be updated on the basis of the state of the power source connected to the first battery chamber 110.

### Third Embodiment

The electronic apparatus 100 and a control method for the electronic apparatus 100 according to a third embodiment are explained below.

In the first and second embodiments, the example is explained in which the type of the power source connected to the first battery chamber 110 is detected.

In the third embodiment, an example is explained in which a special process is performed in a case where power source information corresponding to a type of a power source connected to the first battery chamber 110 is not acquired from the second memory 113 (or the first memory 112).

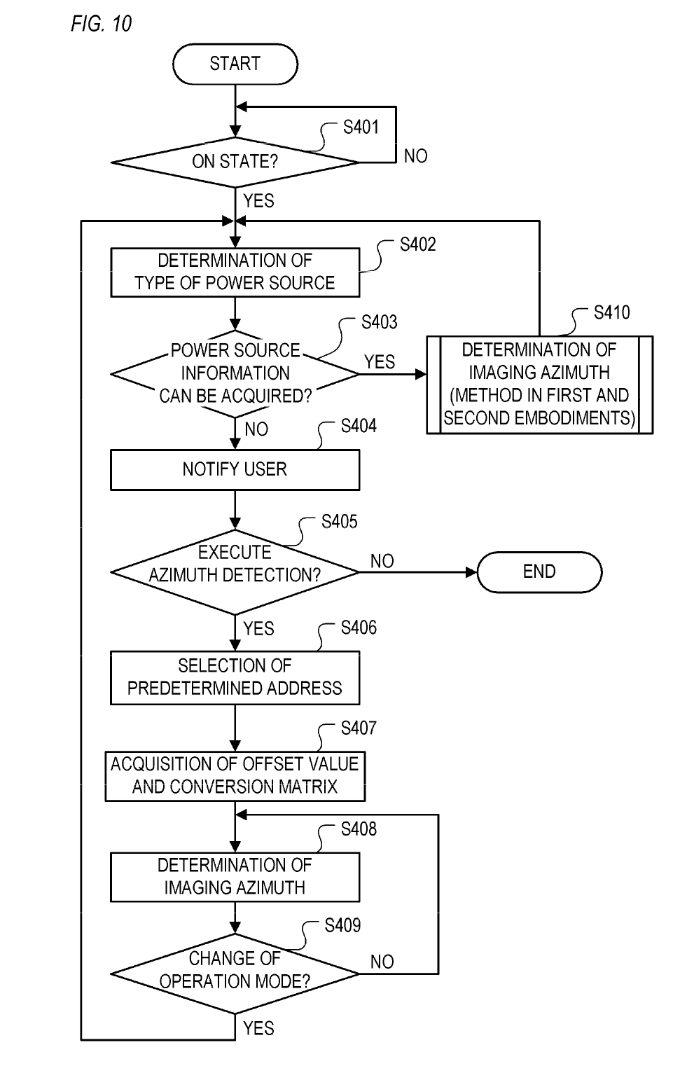

FIG. 10 is a flowchart for illustrating an example of the operation of the electronic apparatus 100 according to the third embodiment.

First, in S401, the CPU 118 determines whether a state of the power switch is switched to an ON state. By switching the state of the power switch to the ON state, the electronic apparatus 100 starts and the CPU 118 proceeds from S401 to S402.

In S402, the power source detecting unit 118a determines a type of the power source connected to the first battery chamber 110.

In S403, the power source detecting unit 118a determines whether power source information corresponding to the type of the power source determined in S402 can be acquired from the second memory 113 (or the first memory 112). A case of “a part of the power supply information is not acquired” also corresponds to a case of “the power supply information is not acquired”. In a case where the power source information can be acquired, the CPU 118 proceeds from S403 to S410. In a case where the power source information is not acquired, the CPU 118 proceeds from S403 to S404.

In S410, an imaging azimuth of the electronic apparatus 100 is determined according to the method explained in the first embodiment or the second embodiment. Then, this flowchart is ended.

In S404, a notifying unit included in the CPU 118 notifies the user of information concerning that the power source information is not acquired. In a case where the power source information is not acquired, the imaging azimuth cannot be highly accurately detected. Therefore, in the third embodiment, the notifying unit notifies the user that detection accuracy of the imaging azimuth is decreased. The notification to the user can be realized by displaying a notification image (an icon, a message, etc.) on a screen. The notification to the user can also be performed using light from a light emitting unit separate from the screen or can also be performed using sound or voice from a speaker or the like.

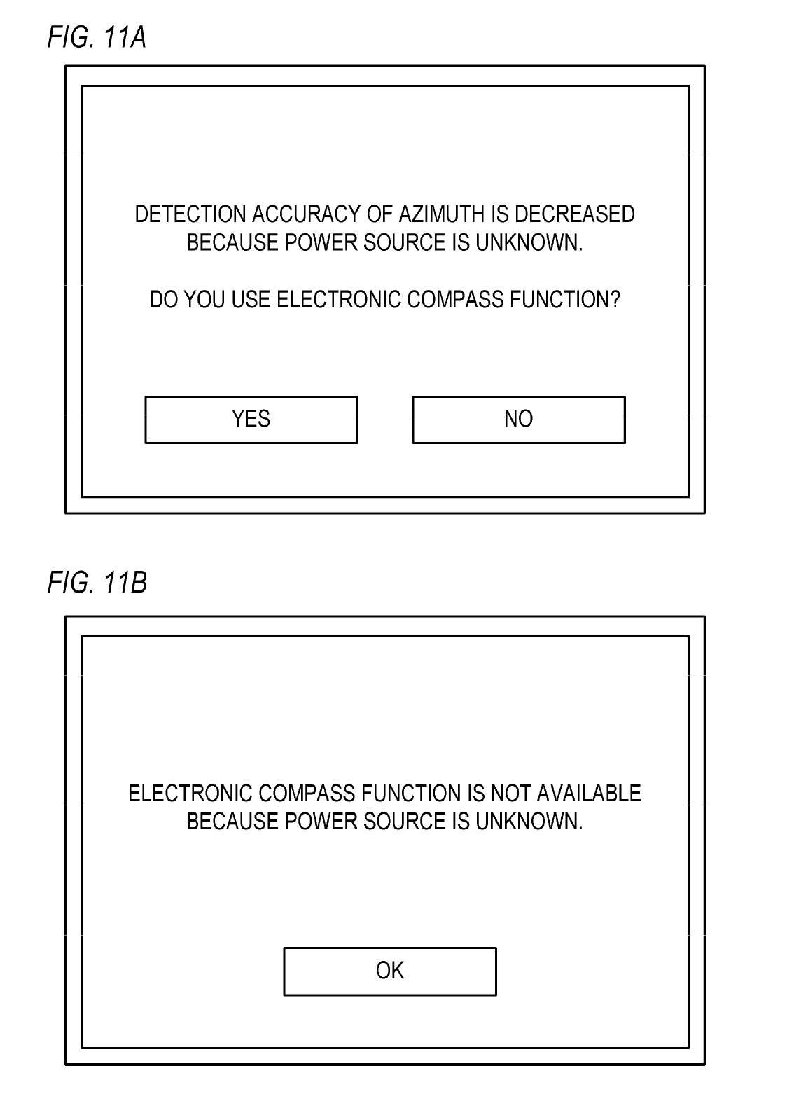

In S404, for example, a notification image shown in FIG. 11A is displayed.

In the notification image shown in FIG. 11A, a message representing the decrease in the detection accuracy of the imaging azimuth “detection accuracy of an azimuth is decreased because a power source is unknown” is described. In the notification image shown in FIG. 11A, a message for confirming with the user whether detection of the imaging azimuth is performed “do you use an electronic compass function?” is described. The notification image shown in FIG. 11A includes an execution button (a button with “Yes” described thereon) operated by the user in a case where the detection of the imaging azimuth is performed and a non-execution button (a button with “No” described thereon) operated by the user in a case where the detection of the imaging azimuth is not performed.

In S405, the CPU 118 determines whether, although the detection accuracy of the azimuth of the electronic apparatus 100 is decreased, the user desires the detection of the imaging azimuth. Specifically, it is determined that which of the execution button and the non-execution button shown in FIG. 11A is selected. In a case where the execution button is selected, it is determined that the user desires to detect the imaging azimuth. The CPU 118 proceeds from S405 to S406. In a case where the non-execution button is selected, it is determined that the user does not desire to detect the imaging azimuth. The process for determining the imaging azimuth is not executed and this flowchart is ended.

In S406, the correction value determining unit 118b reads out, from the second memory 113 (or the first memory 112), for example, the offset value (the first correction value) and the conversion matrix (the second correction value) included in the first power source information. The offset value (the first correction value) read out from the second memory 113 (or the first memory 112) corresponds to the selected operation mode.

In S407, the CPU 118 drives the acceleration sensor 115 and the magnetic sensor 116, acquires an acceleration detection value from the acceleration sensor 115, and acquires a magnetic detection value from the magnetic sensor 116.

In S408, the detection value correcting unit 118c corrects the magnetic detection value acquired in S407 using the offset value (the first correction value) and the conversion matrix (the second correction value) acquired in S406. The azimuth determining unit 118d determines an imaging azimuth using the magnetic detection value after the correction and the acceleration detection value acquired in S407. In a case where the selected operation mode is the still image shooting mode or the moving image shooting mode, the CPU 118 stores information indicating the imaging azimuth determined in S408 in the first memory 112 together with captured image data. In this way, in the third embodiment, in a case where, although the detection accuracy of the imaging azimuth is decreased, the detection of the imaging azimuth is performed, the magnetic detection value is corrected by a predetermined method.

In S409, the CPU 118 determines whether user operation for changing the selected operation mode to another operation mode is performed. In a case where the user operation for changing the selected operation mode to another operation mode is not performed, the CPU 118 returns from S409 to S408 in order to determine an imaging azimuth again. In a case where the user operation for changing the selected operation mode to another operation mode is performed, the CPU 118 returns from S409 to S402.

As explained above, according to the third embodiment, in a case where the power source information is not acquired, information concerning that the power source information is not acquired is notified to the user. Consequently, it is possible to cause the user to grasp that detection of an imaging azimuth cannot be highly accurately executed.

According to the third embodiment, in a case where, although the detection of the imaging azimuth cannot be highly accurately executed, the user desires to detect an imaging azimuth, the magnetic detection value is corrected by the predetermined method. The imaging azimuth is determined using the magnetic detection value after the correction. Consequently, it is possible to meet the desire of the user.

Note that the information concerning that the power source information is not acquired is not limited to the information indicating that the detection accuracy of the imaging azimuth is decreased. For example, information indicating that the imaging azimuth cannot be detected may be notified as the information concerning that the power source information is not acquired. In a case where such information is notified, a process for determining the imaging azimuth is not executed.

The information indicating that the imaging azimuth cannot be detected can be notified to the user by, for example, displaying a notification image shown in FIG. 11B on a screen. In the notification image shown in FIG. 11B, a message indicating that the imaging azimuth cannot be detected “the electronic compass function is not available because the power source is unknown” is described.

Note that the notification to the user does not have to be performed. For example, in a case where the power source information is not acquired, the magnetic detection value may corrected by the predetermined method and the imaging azimuth may be determined using the magnetic detection value after the correction. In a case where the power source information is not acquired, the process for determining the imaging azimuth is not executed and other process (a process corresponding to the operation mode, a process corresponding to the user operation, etc.) may be executed.

### Fourth Embodiment

A personal computer, a microcomputer, a central processing unit (CPU), and the like can also realize the various functions, the various processes, and the various methods explained in the first to third embodiments using a computer program. In the following explanation, in the fourth embodiment, the personal computer, the microcomputer, the CPU, and the like are referred to as “computer X”. In the fourth embodiment, a computer program for controlling the computer X and for realizing the various functions, the various processes, and the various methods explained in the first to third embodiments is referred to as “computer program Y”.

The various functions, the various processes, and the various methods explained in the first to third embodiments are realized by the computer X executing the computer program Y. In this case, the computer program Y is supplied to the computer X via a computer-readable storage medium. The computer-readable storage medium in the fourth embodiment includes at least one of a hard disk apparatus, an optical disk, a CD-ROM, a CD-R, a memory card, a ROM, a RAM, and the like. The computer-readable storage medium in the fourth embodiment is a non-transitory storage medium.

While the present invention is described with reference to exemplary embodiments, it is to be understood that the present invention is not limited to the exemplary embodiments. The scope of the following claims is to be accorded the broadest interpretation so as to encompass all modifications and equivalent structures.

This application claims priority from Japanese Patent Application No. 2014-187053, filed on Sep. 12, 2014, which is hereby incorporated by reference herein in its entirety.

What is claimed is:

1. An electronic apparatus comprising:
a detecting unit that detects a magnetic field and outputs a detection value corresponding to the detected magnetic field;
a correcting unit that corrects the detection value according to a type of a power source connected to the electronic apparatus; and
a determining unit that determines, using the corrected detection value, an azimuth in which a predetermined surface of the electronic apparatus is directed.

2. The electronic apparatus according to claim 1, wherein the power source connected to the electronic apparatus includes one or more batteries.

3. The electronic apparatus according to claim 1, wherein the correcting unit corrects the detection value according to the type of the power source connected to the electronic apparatus so as to correct distortion of a magnetic field that occurs by the power source connected to the electronic apparatus.

4. The electronic apparatus according to claim 1, further comprising a notification unit that notifies a user of information concerning that an azimuth in which the predetermined surface of the electronic apparatus is directed cannot be detected, in a case where the type of the power source connected to the electronic apparatus is not determined.

5. The electronic apparatus according to claim 1, further comprising a notification unit that notifies a user of information concerning that accuracy of a process for detecting an azimuth in which the predetermined surface of the electronic apparatus is directed is decreased, in a case where the type of the power source connected to the electronic apparatus is not determined.

6. The electronic apparatus according to claim 1, wherein the determining unit does not execute a process for determining an azimuth in which the predetermined surface of the electronic apparatus is directed, in a case where the type of the power source connected to the electronic apparatus is not determined.

7. The electronic apparatus according to claim 1, wherein the correcting unit corrects the detection value by a predetermined method, in a case where information relating to the power source is not acquired.

8. The electronic apparatus according to claim 1, further comprising an acquisition unit that acquires information relating to the power source.

9. A method comprising:
causing a detecting unit to detect a magnetic field and output a detection value corresponding to the detected magnetic field;
correcting the detection value according to a type of a power source connected to an electronic apparatus; and
determining, using the corrected detection value, an azimuth in which a predetermined surface of the electronic apparatus is directed.

10. A non-transitory storage medium that stores a program for causing a computer to execute a method, the method comprising:
causing a detecting unit to detect a magnetic field and output a detection value corresponding to the detected magnetic field;
correcting the detection value according to a type of a power source connected to an electronic apparatus; and
determining, using the corrected detection value, an azimuth in which a predetermined surface of the electronic apparatus is directed.

11. An electronic apparatus comprising:
a detecting unit that detects a magnetic field and outputs a detection value corresponding to the detected magnetic field;
a correcting unit that corrects the detection value according to an operation mode of the electronic apparatus in a case where a predetermined power source is connected to the electronic apparatus; and
a determining unit that determines, using the corrected detection value, an azimuth in which a predetermined surface of the electronic apparatus is directed.

12. The electronic apparatus according to claim 11, wherein a power source connected to the electronic apparatus includes one or more batteries.

13. The electronic apparatus according to claim 11, wherein the correcting unit corrects the detection value according to a type of a power source connected to the electronic apparatus so as to correct distortion of a magnetic field that occurs by the power source connected to the electronic apparatus.

14. The electronic apparatus according to claim 11, further comprising an acquisition unit that acquires information relating to the predetermined power source.

15. A method comprising:
causing a detecting unit to detect a magnetic field and output a detection value corresponding to the detected magnetic field;
correcting the detection value according to an operation mode of an electronic apparatus in a case where a predetermined power source is connected to the electronic apparatus; and
determining, using the corrected detection value, an azimuth in which a predetermined surface of the electronic apparatus is directed.

16. A non-transitory storage medium that stores a program for causing a computer to execute a method, the method comprising:
causing a detecting unit to detect a magnetic field and output a detection value corresponding to the detected magnetic field;
correcting the detection value according to an operation mode of an electronic apparatus in a case where a predetermined power source is connected to the electronic apparatus; and
determining, using the corrected detection value, an azimuth in which a predetermined surface of the electronic apparatus is directed.
